(19) United States
(12) Patent Application Publication
(10) Pub. No.: US 2005/0231509 A1
(43) Pub. Date: Oct. 20, 2005

(54) Method of controlling operation of a plastics processing machine from a remote location using true imaging

(75) Inventors: Gunter Grimm, Hilgertshausen (DE); Roman Laberer, Oberroth (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 11/152,701

(22) Filed: Jun. 14, 2005

Related U.S. Application Data
(63) Continuation of application No. PCT/EP03/12489, filed on Nov. 8, 2003.

(30) Foreign Application Priority Data
Dec. 19, 2002 (DE) 102 59 416.3

(51) Int. Cl. G06T 11/20

(52) U.S. Cl. 345/443

(57) ABSTRACT

A method for visual remote control with faithful imaging, whereby a control unit for a plastics processing machine includes a first display screen on which changing display screen information is displayed in pixels arranged line-by-line and the control unit is connected to a remote control unit which includes a second display screen. A universal applicability of a remote control unit is ensured by means of a compression method by which the display content of a control unit is transmitted essentially identically onto the display screen of the remote control unit.

### CROSS-REFERENCES TO RELATED APPLICATIONS

This application is a continuation of prior filed copending PCT International application no. PCT/EP2003/012489, filed Nov. 8, 2003, which designated the United States and on which priority is claimed under 35 U.S.C. §120, and which claims the priority of German Patent Application, Serial No. 102 59 416.3, filed Dec. 19, 2002, pursuant to 35 U.S.C. 119(a)-(d), the subject matter of which is/are incorporated herein by reference.

### BACKGROUND OF THE INVENTION

The present invention relates, in general, to a method of controlling operation of a machine, e.g. a plastics processing machine, from a remote location using true imaging.

There is an increasing demand for allowing a remote-controlled operation of plastics processing machines, in particular extruder and injection molding machines, via communication connections such as cable, modem or Internet. In this context, European Patent EP 917 034 is referred to as state of the art and describes the possibility of remote control of one or more injection molding machines, for example by means of an Internet connection. In addition, compression algorithms are also known to restrict the data quantities to be transmitted.

A problem of current remote control methods and apparatuses is the need to conform (e.g. matching configuration) of remote control station, on one hand, and connected machines, on the other hand. In order to conform the remote control to the respectively connected machine, a separate configuration is typically required. In the event, the remote control unit should be used for another injection molding machine, readjustment becomes necessary. This poses a problem in particular when the remote control is completely integrated in the control unit of an injection molding machine or extrusion machine.

It would therefore be desirable and advantageous to provide an improved method for a remote control of a machine to obviate prior art shortcomings and to ensure a quick and safe diagnostics or remote maintenance option, without a need for excessive modification of the configuration of remote control station and connected machine.

### SUMMARY OF THE INVENTION

According to one aspect of the present invention, a method for a visual remote control with faithful imaging, in which a control unit of a plastics processing machine includes a first display screen for line-by-line illustration of a changing display information, and the control unit is connected to a remote control unit having a second display screen, includes the steps of line-by-line scanning of an image area of the first display screen to provide an information of a display line, compressing the information of the display line in the event a change has occurred in relation to a preceding scanning step, transmitting the compressed information to the remote control unit, decompressing the transmitted information, and constructing an image area of the second display screen by using the transmitted information to reproduce a display content which is substantially identical to a display content of the first display screen.

The present invention resolves prior art problems by transmitting a display content of a control unit of a plastics processing machine 1:1 onto the display screen of a remote control station in such a manner that the changes between a momentary scanning process and a preceding scanning process is transmitted in compressed form. As a consequence of the 1:1 transmission of the display, there is no need for additional modification in the configuration. Rather, the operator is able to read on the remote control monitor all information which is also displayed on the monitor of the actual control unit. While a data transfer of entire display contents would take a relatively long time, transmission of only changes in the display content of a scanned line compared to a preceding display content results in a very fast and safe data transfer by employing suitable compression techniques.

Execution of the method according to the invention thus involves initial line-by-line scanning of the display area of the display screen of the control unit of the plastics processing machine. Following each scanning step, it is checked whether a change has taken place between this display line and a preceding scanning step of the same display line. If affirmative, the data content of the scanned display line is compressed. Data compressed in this way are then transferred to the remote control unit, decompressed there, and displayed on the display screen of the remote control unit. As a result, the display screen of the remote control unit displays substantially the same image information as the display screen of the control unit of the plastics processing machine. By merely transferring changed regions, only part of the information of an entire display has to be transmitted for creating a complete and true image area so that the reproduction of the display on the side of the remote control can be accelerated.

According to another feature of the present invention, the compressing step can be executed by run-length-encoding. While application of this method is currently preferred, other algorithms may, of course, also be used, such as, for example, a so-called deflate algorithm, or a further variation of the LZ77 compression process, or other known algorithms.

According to another feature of the present invention, several compressed display lines (for example n lines) are combined to a data packet, and this data packet can then be transmitted.

The size of transmitted data can be further reduced, when the changed display line is not in its entirety transmitted but rather only the actually changed line portions are transmitted. According to another feature of the present invention, jump instructions, for example, are used for skipping unchanged pixel sequences. The pixel sequences may, for example, be stored in shortened form, for example according to number and pixel sequence.

According to another feature of the present invention, a check may also be incorporated in the method to execute a data compression or to transmit compressed data only, when the data quantity is smaller after compression than the uncompressed data quantity. Only then does compression make sense.

A retransfer of input instructions back from the remote control unit to the control unit of the plastics processing machine can be realized in uncompressed form, as these data quantities are generally of small size. Suitably, the operating system also includes a display screen, a computer unit and an input unit.

### BRIEF DESCRIPTION OF THE DRAWING

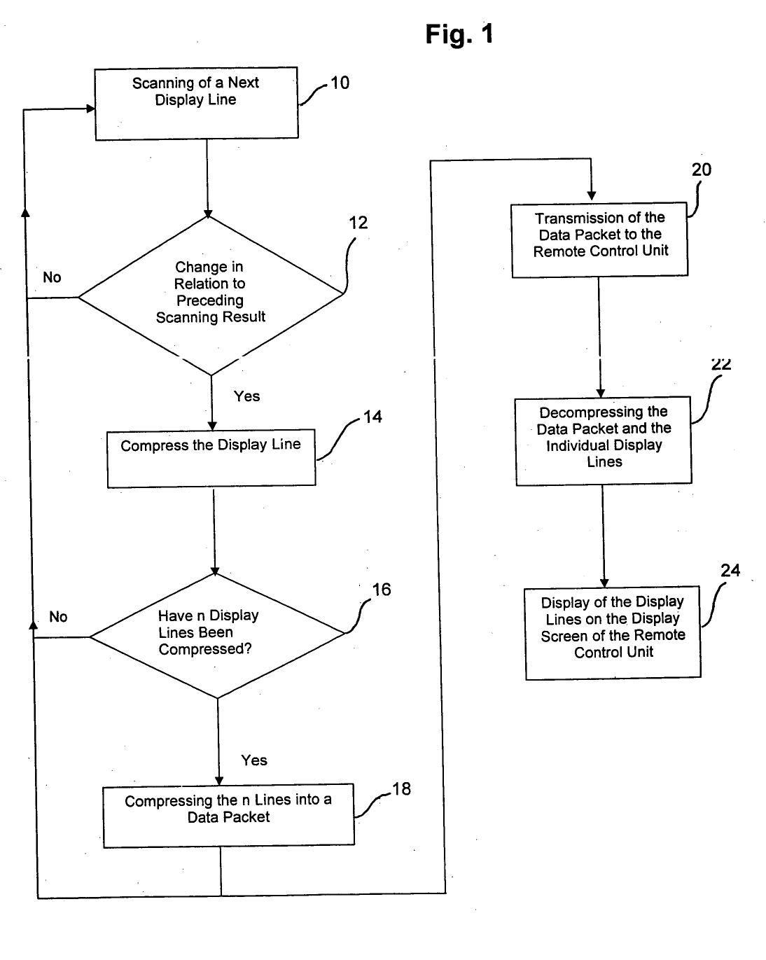

Other features and advantages of the present invention will be more readily apparent upon reading the following description of currently preferred exemplified embodiments of the invention with reference to the accompanying drawing, in which the sole FIG. 1 shows a flow chart of a method according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the sole FIG. 1, there is shown a flow chart of a method according to the present invention. In a first step 10, a particular display line is scanned. In a step 12, a check is executed as to whether the scanned display line has changed in relation to a preceding scanning step of the same display line. If negative, step 10 is repeated to scan a next display line. If affirmative, which means that step 12 has determined a change in relation to a preceding scanning step, the involved display line is compressed (step 14), using the afore-mentioned techniques, such as run-length encoding. These techniques are generally known and available, e.g., on the Internet, so that a further discussion thereof is omitted for the sake of simplicity.

Suitably, only those line portions of the display line, which actually have changed, are compressed.

In step 16, it is checked whether the predefined number of n display lines has already been compressed. The number n may hereby be inputted by an administrator. If the desired number of display lines has not been compressed as of yet, it is reverted back from step 16 and the next display line is scanned (step 10).

If step 16 results in a determination that n-display lines have been compressed, a data packet is formed by further compressing the n compressed display lines in step 18. This compression may be realized according to the LZW algorithm. This data packet is then transferred in step 20 to the unillustrated remote control unit. At the same time, it is again reverted back to step 10 for scanning a next display line.

In step 22, the data packet as well as the individual display lines are decompressed on the side of the remote control unit, and on the basis of this information the display is reproduced in respectively modified form in step 22, using the transmitted data that changed in relation to a preceding scanning step in the first display screen of the control unit. Thus, a true image of the display information on the control side of the plastics processing machine is thus also available in a rapid and simple manner on the side of the remote control. This information enables the remote operator to recognize a diagnosis or to execute a necessary remote-controlled operation. The operator can hereby input instructions or parameter information, using possible existing input means on the remote control side and transmit them to the injection molding machine. As these data contain only relatively small data quantities, there is generally no need to compress these data.

The method according to the present invention eliminates the need for adapting the configuration of remote control unit and control unit of the plastics processing machine. The remote control system can be applied flexibly.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A method for a visual remote control with faithful imaging, in which a control unit of a plastics processing machine includes a first display screen for line-by-line illustration of a changing display information, and the control unit is connected to a remote control unit having a second display screen, comprising the steps of:
line-by-line scanning of an image area of the first display screen to provide an information of a display line;
compressing the information of the display line in the event a change has occurred in relation to a preceding scanning step;
transmitting the compressed information to the remote control unit;
decompressing the transmitted information; and
constructing an image area of the second display screen by using the transmitted information to reproduce a display content which is substantially identical to a display content of the first display screen.

2. The method of claim 1, wherein the compressing step is executed by run-length-encoding.

3. The method of claim 1, wherein successive identical pixel sequences of a row of pixels are combined in the display line and stored in a format with number and pixel sequence.

4. The method of claim 3, and further comprising the step of skipping unchanged pixel sequences, when the content of the display line has changed partially.

5. The method of claim 1, wherein the compressing step of the display line is suppressed when a quantity of non-compressed information is smaller than a compressed data quantity.

6. The method of claim 1, and further comprising the step of compressing several compressed display lines before being transmitted to the remote control unit.

7. The method of claim 1, and further comprising the steps of inputting data by an input unit of the remote control unit and transmitting the data to the control unit of the plastics processing machine.

8. A method of operating a machine from a remote location, comprising the steps of:
(a) scanning a display line of an image on a display screen of a control unit of a machine;
(b) comparing the scanned display line of the image with a display line scanned immediately beforehand to determine if a change has occurred;
(c) compressing data commensurate with the scanned display line if the comparing step resulted in a determination of a change;
(d) transmitting the data to a remote control unit having a display screen;
(e) decompressing the data; and
(f) reproducing a true copy of the image on the display screen of the control unit of the plastics processing machine on the display screen of the remote control unit.

9. The method of claim 8, wherein the scanning step includes dividing the display line into a finite number of pixels which are combined in a sequence and stored as a series of data.

10. The method of claim 9, wherein the transmitting step includes the step of transmitting only a changed pixel sequence while skipping a portion of an unchanged pixel sequence.

11. The method of claim 8, and further comprising the steps of checking a quantity of data to be compressed before executing the compression step, and executing the compressing step only when resulting in a reduction of data for subsequent transmission.

12. The method of claim 8, and further comprising the step of repeating the steps (a) to (c) to provide a data packet of several compressed display lines, and compressing the data packet before the transmitting step.

13. The method of claim 8, and further comprising the step of inputting data into the remote control unit for transmission to the control unit for operation of the machine.
